(19) United States
(12) Patent Application Publication
(10) Pub. No.: US 2013/0170417 A1
(43) Pub. Date: Jul. 4, 2013

(54) Distributed low-power monitoring system

(71) Applicants: Evan A. Thomas, (US); Michael E. Fleming, (US); William K. Spiller, (US); Chun Kit Chan, (US); Zdenek Zumr, (US)

(72) Inventors: Evan A. Thomas, (US); Michael E. Fleming, (US); William K. Spiller, (US); Chun Kit Chan, (US); Zdenek Zumr, (US)

(21) Appl. No.: 13/605,828

(22) Filed: Sep. 6, 2012

Related U.S. Application Data
(60) Provisional application No. 61/531,579, filed on Sep. 6, 2011.

(51) Int. Cl. H04W 52/02

(52) U.S. Cl. CPC H04W 52/0216
USPC 370/311

(57) ABSTRACT

A distributed wireless monitoring system with low-power remote sensors includes data encoding/compression at sensors to reduce power use from transmission and storage (where the compact data representation is decoded after upload), event activated operation/data logging, remote configuration of event triggering thresholds and correlation templates, distributed processing capabilities, and sensor clock synchronization from a network time service.

### CROSS-REFERENCE TO RELATED APPLICATIONS

This application claims priority from U.S. Provisional Patent Application 61/531,579 filed Sep. 6, 2011, which is incorporated herein by reference.

### FIELD OF THE INVENTION

The present invention relates generally to variable event-based distributed wireless monitoring systems with low-power remote sensors, data logging, communications, and remotely relayed instructions.

### BACKGROUND OF THE INVENTION

Current data loggers for distributed wireless monitoring systems may be classified into four types:

1. Schedule—logging intervals are scheduled at specific times, such as every 15 minutes. The range of operation is typically once every second up to once every 24 hours.

2. Pulse—A cumulative pulse sensor that monitors usage and outputs a pulse when a predetermined value has been met. Water flow can be monitored with a pulse sensor and could be programmed to output a pulse signal for every gallon of water that flows over the sensor. But this is only one sensor that triggers an event to log.

3. State—used for a change of state (open or closed/on or off). The logger records the duration of the event—how long (seconds, minutes, hours) a device is on or off to calculate a run-time. Devices or sensors that output a contact closure, or simple magnetic switch device, can be used to trigger a change in state. Only one sensor triggers the change of state.

4. Event—Used to record the number of events that occur, but not the duration such as a switch going from closed to open. This is typically used in a rain gage tipping bucket application. When the sensor detects and even occurred (such as a tip of a tipping bucket), and event is logged (i.e., one tip). Again, such logging is based on only one sensor.

Representative examples of the current state of the art are described in the following references, which are incorporated herein by reference:

US Patent Application Pub. No. 2002/0078173

US Patent Application Pub. No. 2006/0176169

US Patent Application Pub. No. 2006/0137090

US Patent Application Pub. No. 2009/0058663

US Patent Application Pub. No. 2009/0076343

US Patent Application Pub. No. 2010/0106269

U.S. Pat. No. 6,208,247

U.S. Pat. No. 6,735,630

### SUMMARY OF THE INVENTION

The invention relates to a distributed wireless monitoring system with low-power remote sensors. Notable major features of the system include data encoding/compression at sensors to reduce power use from transmission and storage (where the compact data representation is decoded after upload), event activated operation/data logging, remote configuration of event triggering thresholds and correlation templates, distributed processing capabilities, and sensor clock synchronization from a network time service.

In one aspect, the present invention provides data logging techniques which enjoy one or more of the following advantages:

1) The event being logged is not based on only one sensor, but based on comparing the value of two independent sensor measurements.

2) In contrast with most of the pulse, state or event loggers which function with a limited range of signal types because they are based on on/off, open/closed or other yes or no type events, our event based data logger can use a variety of sensor signals comparing variable conditions between two sensors (not a yes or no type event).

3) The division of decision processing between the local sensor and off site computational resources.

Thus, in one aspect, the present invention provides an event, pulse, state based data logger that is activated based on predetermined differences between two sensors.

Moreover, embodiments allow low power operation and connectivity control of the comparative values via the Internet.

In one aspect, the present invention provides distributed wireless monitoring systems which may include one or more of the following features: data encoding/compression at sensors to reduce power use from transmission and storage (where the compact data representation is decoded after upload), event activated operation/data logging based on predetermined comparison thresholds between two independent sensors, remote configuration of event triggering thresholds and correlation templates, distributed processing capabilities, and sensor clock synchronization from a network time service.

The present invention includes smart-sensor technology designed to have a low power profile, while maintaining high resolution data logging capabilities. Most prior data loggers have a tradeoff between frequency of sampling/logging and energy consumption. However, for these applications infrequent sampling and logging (anything less than every second) can result in missing usage events that are of interest.

Embodiments of the present invention address this issue by sampling values from one or two independent sensors at a comparatively high rate, e.g., eight times a second, while only logging and relaying the data when a predetermined change in one or more parameters being sampled. This thereby reduces power consumption and allows high resolution logging of usage events while running off of compact batteries for a targeted minimum of six months.

Low power, affordable, low profile remote monitoring can provide solutions to many of the issues around sustainability of water, energy and infrastructure interventions. Near real-time data can be inexpensively logged and analyzed to optimize the performance of the particular intervention. Data can be used to understand programmatic, social, economic, and seasonal changes that may influence the quality of the system. Additionally, behavioral patterns such as how and when a system is being used can be analyzed to help develop a sustainable system by integrating the user's behaviors into the design and modification of the system.

Sensors may be operated autonomously. During installation, the sensor is powered, and then relays operational usage and performance data in remote communities around the world directly to the Internet via periodic Wi-Fi and GPRS uploads. The data is directly analyzed on a web-based software program, allowing reduced power consumption locally, and enabling efficient and economic comprehensive data analysis.

In preferred embodiments, commercially available front-end sensors suitable for the target application are integrated into the comparator board. These sensors can be a differential pressure transducer for water applications, a switch for latrines, thermocouples and CO/CO2 sensors for cook stoves, or motion sensors for pedestrian infrastructure. The comparators sample the sensors frequently, and the output is fed into a low-power microcomputer chip where the relative time that the parameter change occurs is logged. Logging of the sensors measurement continues until the parameter returns to a predetermined baseline. The stored events are coded to reduce the amount of data and, thereby, the amount of energy required for transmission. Once coded by the microcomputer, this data and up to eleven other sensors data sets are sent either via wired, Bluetooth or Wi-Fi to a parent board or directly to the internet. The reconfigurable GSM modem is used to report the buffered sensor data sets once a day or several times a day. After all the reporting data is received from the logger, the modem acquires a cell tower channel and connects to an Internet database on a server and transmits the formatted sensor data sets for storage into an internet web-based database program on a server. If the cell phone telemetry experiences any outages, large amounts of data stored on the logger can be retrieved once the cell channel is re-established. Through the Internet, the data is then integrated with a web-enabled data sharing platform that allows continuous review and analysis of the collected data by the project team and partners, from anywhere in the world.

The distributed methods of data analysis allow some processing to be performed locally on the board, such as some averaging, trigger events, logging, offsets, gains, etc., while processing algorithms for summary statistics and alarm events may be done on the Internet Cloud, allowing high performance with low power consumption.

This architecture may be applied to other sensor applications, such as biogas generators, footbridges, water treatment systems, machine performance, security, etc. This is accomplished through the selection of commercially available sensors selected to provide key data parameters on performance and usage of target technologies. These sensors may be pressure transducers, switches, gas emissions sensors, vibration sensors, cameras, water quality sensors, electrical current sensors, solar irradiance sensors, soil moisture sensors, water level sensors, temperature sensors, humidity sensors, motion sensors, etc., that indicate usage frequency and performance in situ. These sensors then directly integrate with the control board that samples the sensors periodically, detects trigger events, logs usage events, and relays consolidated data files to the Internet Cloud.

The boards may be adapted to directly integrate GPRS modules to eliminate the need for a base station for relay to the internet. In this embodiment, a GPRS module, connected to a SIM card (where needed) is directly integrated on the circuit board and obtains a cellular network tower periodically to relay the sensor data directly to the internet cloud.

These designs may be used for remote control of applications, such as simple tasks like opening a valve, controlling a pump, turning on a UV lamp, alerting users to problems, etc. For example, the Internet Cloud database may periodically provide to the distributed sensor boards updated control parameters. These parameters may be interpreted by the boards to turn on or off actuators such as alarms, valves, lights, etc., based on a schedule and/or triggered events.

Data analysis may be ongoing during the duration of each of the projects profiled. The data may be analyzed for significant differences between the survey data and instrumented monitoring data. Additional analysis may be conducted to understand patterns between the monitoring data and secondary data. Specifically, usage and performance data may be recorded to gain insight into the operational effectiveness of the interventions. In all technology cases, the actual recorded usage rates and performance of the interventions may be compared to survey reporting by the end-users. Likewise, the performance of the units may be compared to manufacturer statements and organizational reporting.

Based on the analysis of data, and measures of accountability created with the implementation of the monitoring systems, standards may be proposed for organizations implementing point-of-use water and energy devices in developing communities which may include implementation of objective continuous monitoring devices.

Ultimately, it is anticipated that these systems may be transformative for over 800 million people who currently lack access to safe drinking water, and nearly three billion people who use biomass for their daily energy needs and may benefit from greater accountability and data collection on water, energy and infrastructure projects conducted in their communities. Remote monitoring systems are an innovative method to ensure the success of appropriate technology projects. Rather than infrequent engagement, remote monitoring systems ensure that community partnerships are maintained. This approach seeks to raise the quality and accountability of these projects internationally by separating success from propaganda. Additionally, by providing monitored data on the appropriateness and success of pilot programs, business investors can make informed decisions. These targeted customers are the end-users, but not the end-beneficiaries. The primary beneficiaries are ultimately residents in developing communities who are the targets of international development sector interventions.

To make the system more adaptable to varying environmental stimulus, reporting times, comparator trip points, system reaction parameters, and onsite firmware are dynamically adjusted remotely using Cloud computing. These updates can take place anytime transparent to any system operational requirements.

If needed, reduced telemetry data costs are achieved through on demand onsite data reduction using frequency domain adaptive filtering techniques. In this embodiment, the sensor boards locally interpret the trigger events and sensor values and maps these data profiles to known event characteristics. The boards then log the nature of the event rather than the complete data set, thereby reducing power consumption and telemetry volume.

In each case, the sensor system accurately and non-invasively detects usage events by signal spectral response. For example, in the case of water flow rate monitoring, spikes and drops in pressure are detected by the boards and indicate a usage event. Then, water flow is determined by minute differential pressures using simple durable transducers. If the system fails the flow and use of water continues as before without any blockage or contamination.

Very low standby power consumption coupled with event activated system processing and real-time Cloud computer power optimization allows battery operation for long periods of time. If a sensor exhibits rare use at certain times of the day or week, that system can reduce its data logging during those times to save battery power. If the Cloud computer is told ahead of time that the occupants are going to be gone, that sensor or sensors can be left in low power sleep mode until they return.

Unique extremely low noise full differential signal processing and wide dynamic range analog-to-digital signal conversion preserve the overall system sensitivity allowing measurements and adaptations previously considered unachievable.

High level Internet protocols including encryption are invoked onsite to insure Cloud computing compatibility and system data integrity. Additionally, raw data measurements and system calculations are stored locally in the case of telemetry failures and retransmitted later when the telemetry recovers.

The overall system is uniquely designed to share resources when needed. As the numbers of installations grow the very significant hardware resources in each onsite sensor module can be used to perform small pieces of an application or many different applications when needed. The dynamic interaction between the remote sensors and Internet web services enables powerful computation such as minimum, maximum and average values in additions to complex mathematical formulas. Such information can be used to automatically recalibrate, offset, log time and reporting time and send this information back to the sensor module. This combination of remote sensor and Internet data processing creates and unique smart sensor technology. The application code for powerful distributed processing can be developed and downloaded dynamically to each sensor module on the fly. Process hungry applications like signal and even image pattern recognition can need vast computer resources for very brief periods of time for use in emergency decision making and system optimization.

As our applications evolve into newer requirements having this ever growing distributed compute resource combined with our current dynamically scalable Cloud computing resources allows us to address even the most demanding needs such as environmental contamination detection and tracking using visual and hyper-spectral image pattern recognition.

Overtime the system can learn and store a library of very valuable intellectual property within a web-based data base in the form of correlation templates that are constantly updated and used to accurately identify a growing number of environmental biohazards and their byproducts. Such a library of data and images can rapidly be compared to similar values and images being measured and reported by the remote sensors to quickly identify potential anomalies of concern and report such concerns to the appropriate authority.

The SWEETSense™ combines commercially available front-end sensors, selected for specific applications including water treatment, sanitation, energy, infrastructure or other applications, with a comparator circuit board that samples these sensors at a reasonably high rate. One or more times per day, the sensor board relays logged data events directly to the internet via GPRS cellular networks or Wi-Fi. Data processing is enabled on an internet-based software program, SWEETData™ where the primary algorithms are stored. The internet based program also contains manually and automatically updated calibration files that are periodically and automatically relayed back to the local sensor boards.

The innovations in this invention include the processes used to enable long duration operation with high resolution data logging while operating on simple, small batteries; the use of customized and remotely updatable threshold trigger events; and the distributed data processing load between the local sensors and the internet.

Key Features/Advantages:
Distributed processing between hardware and cloud
Remote automated pseudo and actual calibration
Yielding ultra low power and high performance

The current state-of-the-art for sensor data acquisition systems involves a tradeoff between frequency of sampling/logging and energy consumption. And these systems require multiple different components (sensor, microprocessor, logger, radio, antenna, power supply) that are packaged and sold separately thereby driving cost, complexity and power consumption. Additionally, many existing systems require specialized software to collect and analyze the data.

Instead, the SWEETSense hardware is a fully integrated hardware solution that includes the front-end sensor, the processing hardware, the radio and the power supply, all packaged together and managed in a way that maximizes the value of the data and minimizes power consumption. The data is transmitted to a internet-cloud based platform that is accessible through any standard internet browser. This architecture has enabled the system to be significantly lower cost and more accessible to the end-user. The two images below show the current industry standard approach, compared against the SWEETSense architecture.

There are several key features on both the SWEETSense hardware and the SWEETData software sides that enable this high performance. These are briefly described in the table below.

Table 1: Key features of SWEETSense and SWEETData

SWEETSense Hardware Product
low power (300 microamps nominal)—5×AA batteries=6-18 months
low cost—$100-$500
high sampling rate—up to 8 Hz
Customizable—15 sensor inputs—8 contact, 7 analog to digital
triggered event logging
battery level reporting
WiFi or cellular network reporting
cloud-based processing
remote auto calibration
US Patent-Pending

SWEETData Software Service
Accessible from any browser
Protected login
Maps and visualizes data
Data download
Can be integrated with other data sets and applications
Automatic and manual updating of sensor calibration, reporting and alarm parameters
Alarm condition notification
Integration with other web-based data platforms

The figures show several of the various applications for the SWEETData platform, and illustrate the relationship between the end-user application, the SWEETData hardware platform, and the remote communication between the hardware and software platforms.

### BRIEF DESCRIPTION OF THE DRAWINGS

FIG. 1: Historical integrated data communication system

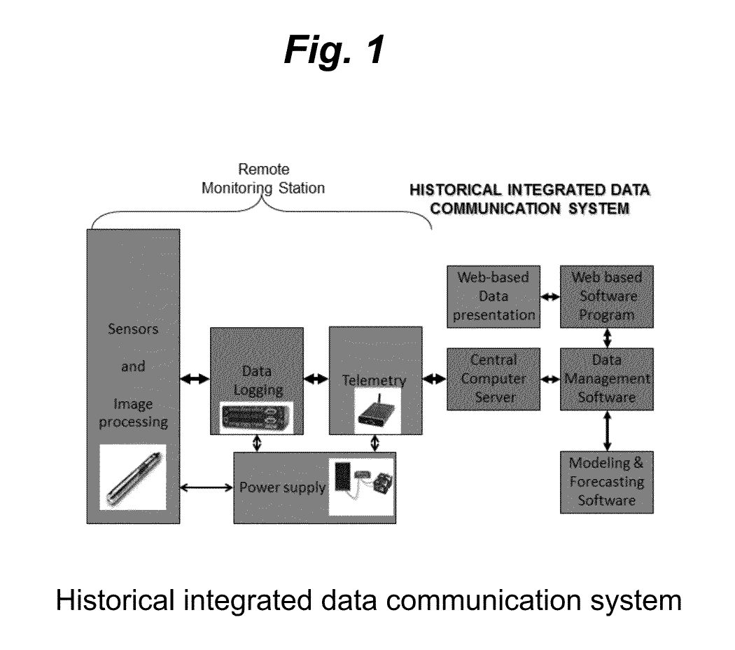

FIG. 2: SWEETSense/SWEETSData architecture

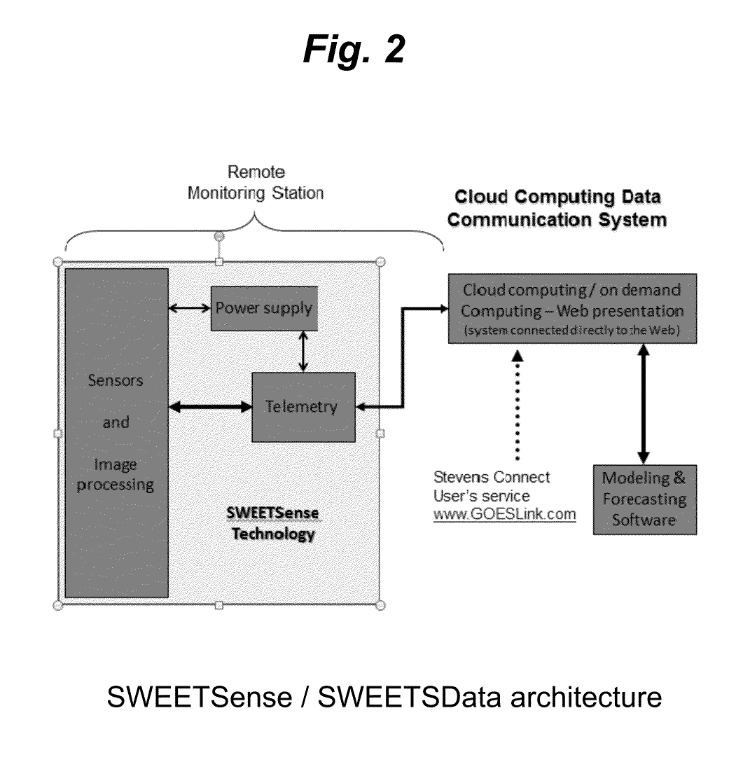

FIG. 3: Graphical representation of various sensor applications connecting to SWEETData hardware with remotely relayed data and configuration instruction communication with SWEETData

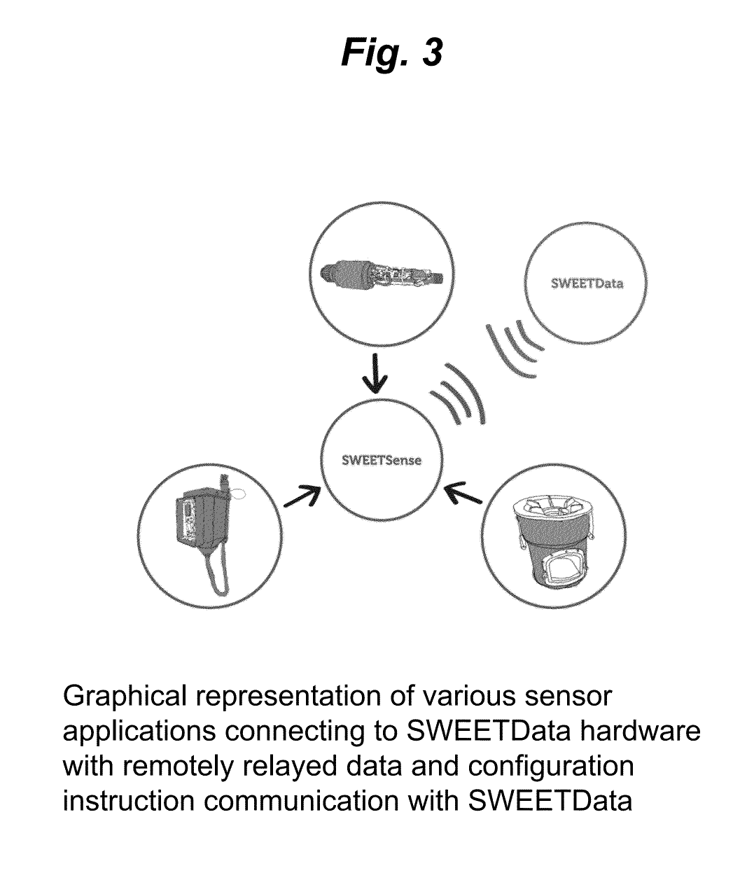

FIG. 4: Example applications/sensor inputs

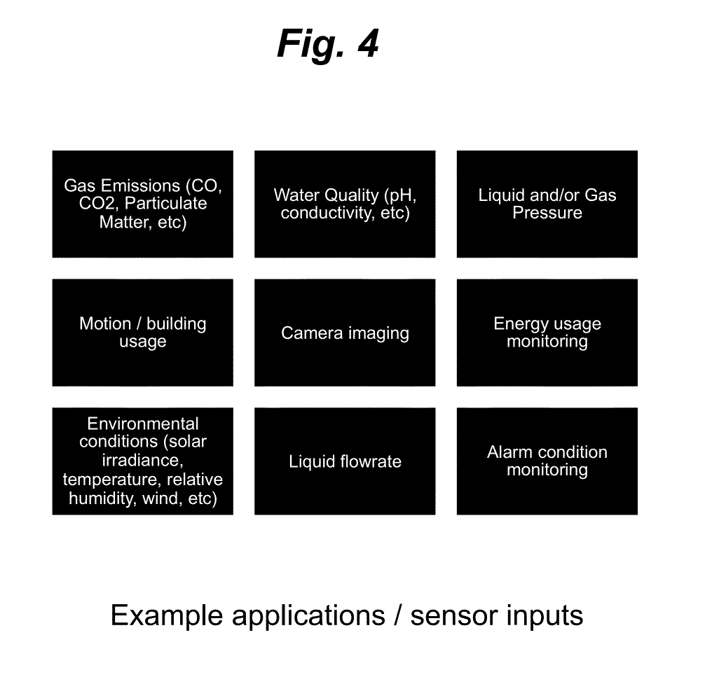

FIG. 5: SWEETSense hardware platform

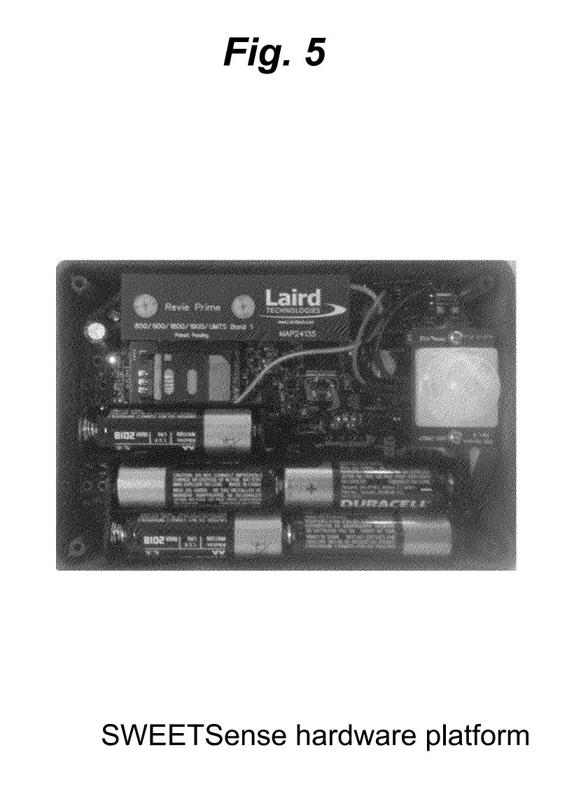

FIG. 6: www.sweetdata.org internet platform

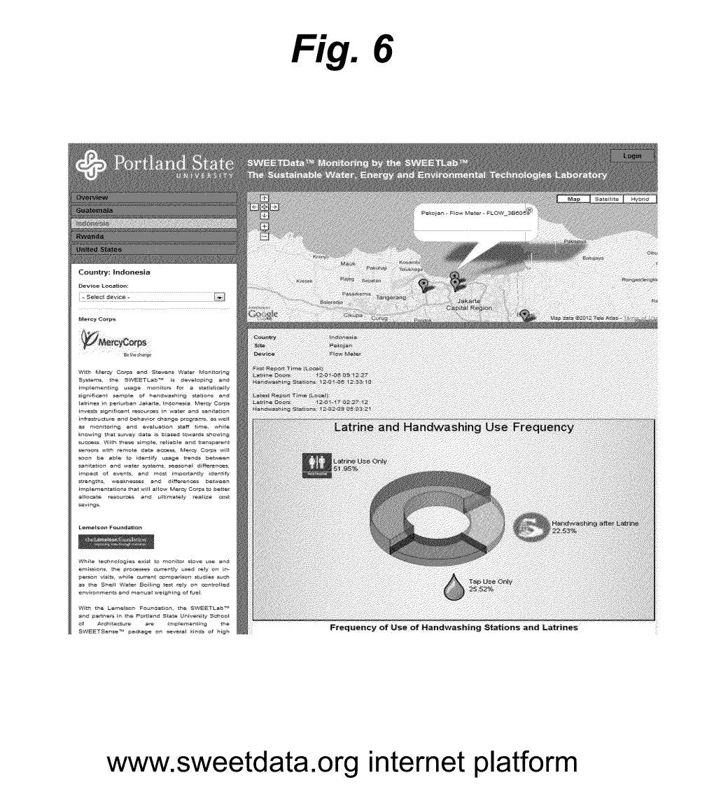

FIG. 7: Frequency domain filtering

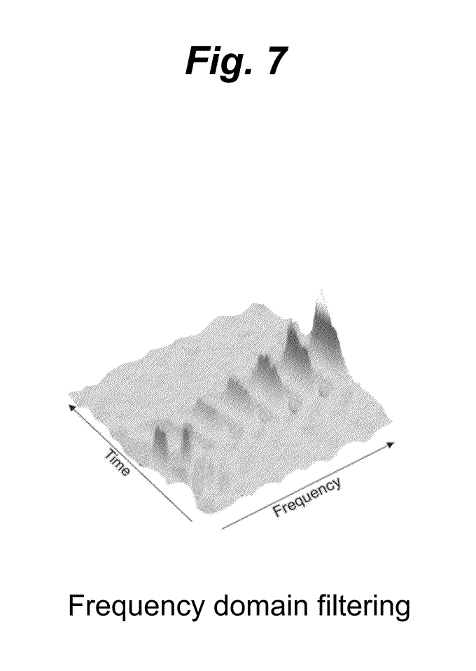

FIG. 8: Smart power management

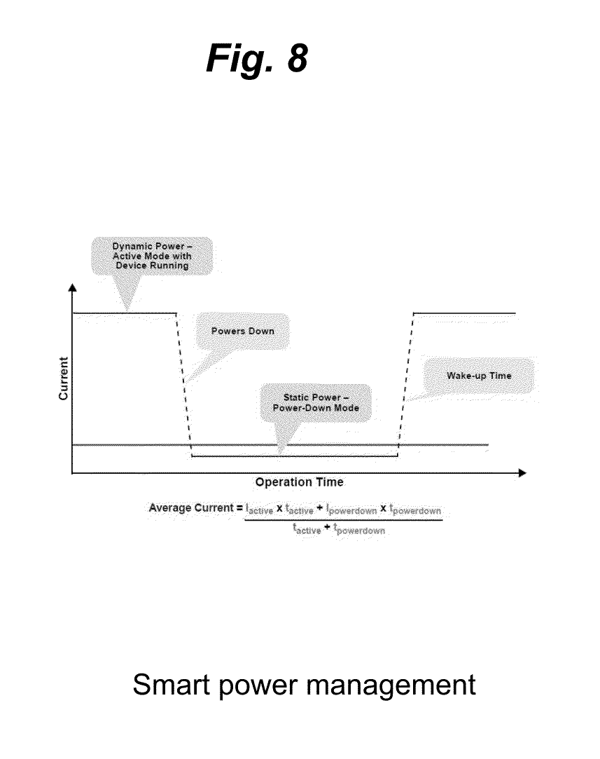

### DETAILED DESCRIPTION

In one aspect, the present invention provides distributed wireless monitoring systems which may include one or more of the following features: data encoding/compression at sensors to reduce power use from transmission and storage (where the compact data representation is decoded after upload), event activated operation/data logging based on predetermined comparison thresholds between one or several independent sensors, remote configuration of event triggering thresholds and calibration values, alarm condition notifications, distributed processing capabilities, and sensor clock synchronization from a network time service.

The present invention includes smart-sensor data platform technology designed to have a low power profile, while maintaining high resolution data logging capabilities. Most prior data loggers have a tradeoff between frequency of sampling/logging and energy consumption. However, for these applications infrequent sampling and logging can result in missing usage events that are of interest.

Embodiments of the present invention address this issue by sampling values from one or more independent sensors at a comparatively high rate, e.g., eight times a second, while only logging and relaying the data when a predetermined change in one or more parameters being sampled. This thereby reduces power consumption and allows high resolution logging of usage events while running off of standard compact batteries for a targeted minimum of six months.

Low power, affordable, low profile remote monitoring can provide solutions to many of the issues around sustainability of water, energy and infrastructure interventions. Near real-time data can be inexpensively logged and analyzed to optimize the performance of the particular intervention. Data can be used to understand programmatic, social, economic, and seasonal changes that may influence the quality of the system. Additionally, behavioral patterns such as how and when a system is being used can be analyzed to help develop a sustainable system by integrating the user's behaviors into the design and modification of the system.

Sensors may be operated autonomously. During installation, the sensor is powered, and then relays data directly to the Internet via periodic Wi-Fi and GPRS uploads. The data is directly analyzed on a web-based software program, allowing reduced power consumption locally, and enabling efficient and economic comprehensive data analysis. The web-based platform is accessible through any standard internet browser, and is also configured to relay instructions including trigger thresholds and calibration values to the remotely located sensors.

In preferred embodiments, commercially available front-end sensors suitable for the target application are integrated into the comparator board. These sensors can be any number of a variety of available sensors, including differential pressure transducers, a motion detector, a camera, thermocouples, gas emissions sensors, and water quality sensors. The comparator circuit sample the sensors at a configurable frequently, and the output is fed into a low-power microcomputer chip where the relative time that the parameter change occurs is logged. Logging of the sensors measurement continues until the parameter returns to a second configurable threshold. The stored events are coded to reduce the amount of data and, thereby, the amount of energy required for transmission. Once coded by the microcomputer, this data and up to thirteen other sensors data sets are sent either via wired, Bluetooth, Wi-Fi or cellular GPRS to a parent board or directly to the internet. The configurable transmission protocol is used to report the buffered sensor data sets once a day or several times a day. In the cellular GPRS embodiment, the modem acquires a cell tower channel and transmits the formatted sensor data sets for storage into an internet web-based database program on a internet cloud-based server. If the cell phone telemetry experiences any outages, large amounts of data stored on the logger can be retrieved once the cell channel is re-established. Through the Internet, the data is then integrated with a web-enabled data sharing platform that allows continuous review and analysis of the collected data by customers, from anywhere in the world.

In another demonstrated embodiment, a data “SD” card is contained on the sensor board, and can log data locally for periodic manual retrieval.

The distributed methods of data analysis allow some processing to be performed locally on the board, such as some averaging, trigger events, logging, offsets, gains, etc., while processing algorithms for summary statistics and alarm events may be done on the Internet Cloud, allowing high performance with low power consumption. The internet cloud based program can remotely re-configure the hardware platforms.

These designs may be used for remote control of applications, such as simple tasks like opening a valve, controlling a pump, turning on a UV lamp, alerting users to problems, etc. For example, the Internet Cloud database may periodically provide to the SWEETSense™ distributed sensor boards updated control parameters. These parameters may be interpreted by the SWEETSense™ boards to turn on or off actuators such as alarms, valves, lights, etc., based on a schedule and/or triggered events.

To make the system more adaptable to varying environmental stimulus, reporting times, comparator trip points, system reaction parameters, and onsite firmware are dynamically adjusted remotely using Cloud computing. These updates can take place anytime transparent to any system operational requirements.

If needed, reduced telemetry data costs are achieved through on demand onsite data reduction using frequency domain adaptive filtering techniques. In this embodiment, the SWEETSense™ boards locally interpret the trigger events and sensor values and maps these data profiles to known event characteristics. The boards then log the nature of the event rather than the complete data set, thereby reducing power consumption and telemetry volume.

The figure below shows this concept applied using two pressure transducers attached to a drinking water line. In this embodiment, the transducer comparator examines the reported water pressure data and waits for a user to open a tap. When the sudden drop in water pressure is observed, the SWEETSense™ stack starts logging the actual pressure readings until the user closes the tap. Closing the tap will cause a ‘water hammer’ effect, resulting in spiking pressure readings, as shown in the frequency chart below. These spikes are used to indicate when pressure data logging is discontinued, allowing the SWEETSense™ unit to return to low power sampling without logging. Two pressure transducers, or a single differential pressure transducer, across an orifice or pipe diameter difference allows correlation of differential pressure readings to volumetric flow rate.

In each case, the SWEETSense™ system accurately and non-invasively detects usage events by signal spectral response. For example, in the case of water flow rate monitoring, spikes and drops in pressure are detected by the boards and indicate a usage event. Then, water flow is determined by minute differential pressures using simple durable transducers. If the system fails the flow and use of water continues as before without any blockage or contamination.

Very low standby power consumption coupled with event activated system processing and real-time Cloud computer power optimization allows battery operation for long periods of time. If a sensor exhibits rare use at certain times of the day or week, that system can reduce its data logging during those times to save battery power. If the Cloud computer is told ahead of time that the occupants are going to be gone, that sensor or sensors can be left in low power sleep mode until they return.

Unique extremely low noise full differential signal processing and wide dynamic range analog-to-digital signal conversion preserve the overall system sensitivity allowing measurements and adaptations previously considered unachievable.

High level Internet protocols including encryption are invoked onsite to insure Cloud computing compatibility and system data integrity. Additionally, raw data measurements and system calculations are stored locally in the case of telemetry failures and retransmitted later when the telemetry recovers.

The overall system is uniquely designed to share resources when needed. As the numbers of installations grow the very significant hardware resources in each onsite sensor module can be used to perform small pieces of an application or many different applications when needed. The dynamic interaction between the remote sensors and Internet web services enables powerful computation such as minimum, maximum and average values in additions to complex mathematical formulas. Such information can be used to automatically recalibrate, offset, log time and reporting time and send this information back to the sensor module. This combination of remote sensor and Internet data processing creates and unique smart sensor technology. The application code for powerful distributed processing can be developed and downloaded dynamically to each sensor module on the fly. Process hungry applications like signal and even image pattern recognition can need vast computer resources for very brief periods of time for use in emergency decision making and system optimization.

As our applications evolve into newer requirements having this ever growing distributed compute resource combined with our current dynamically scalable Cloud computing resources allows us to address even the most demanding needs such as environmental contamination detection and tracking using visual and hyper-spectral image pattern recognition.

Overtime the system can learn and store a library of very valuable intellectual property within a web-based data base in the form of correlation templates that are constantly updated and used to accurately identify a growing number of environmental biohazards and their byproducts. Such a library of data and images can rapidly be compared to similar values and images being measured and reported by the remote sensors to quickly identify potential anomalies of concern and report such concerns to the appropriate authority.

A key innovation of this sensor data acquisition platform is the nominal low-power consumption of approximately 300 microamps. This is achieved through several innovative design features, including:
The units use the Semiconductor Industries lowest power microcomputers manufactured by Microchip.com.
During nominal operation, the sensor platform is in sleep mode, and all on-chip and off-chip peripherals are using little or no current until activated by a change in the sensed parameter.
The most significant power usage occurs when each unit reports data and receives configuration parameters from the internet cloud database. Power usage is minimized by logging data locally and reporting on a user-configured scheduled, between approximately every 5 minutes to once every 24 hours. These report intervals can also be dynamically autonomously optimized using cloud-based processing. For example, the sensor boards can be configured to only report when a certain threshold of data is recorded, rather than on a programmed schedule.
Several sensor inputs from different applications can be integrated into the same sensor board. For example, a single board of integrated power supply, logger and radio can take inputs from air quality and water quality sensors separately.
The boards report directly to the internet over the HTTP protocol, and receives instructions and current time/date information from the cloud server. This significantly reduces the duration of the reporting.
Should the communications protocol be disrupted by connectivity issues, such as maintenance on a cellular network tower, the sensor board will return to sleep mode after several connection attempts, rather than remaining on.
Each sensor board uses adaptive data compression coding algorithms to reduce the amount of data transmitted to the cloud server, less data transmitted equates to a shorter time the cell module needs to be on and therefore longer battery life.
In one embodiment, the sensor board can be deployed with a battery charging solar panel, and its battery voltage can be monitored and trended more often to decide which power saving mode to operate in.
Each board can autonomously effect an emergency alarm such as low battery capacity and contact the internet cloud server independent of any local event triggers.

When measuring the overall power consumption of a system, there are two values which are of primary concern—average power consumption and maximum power consumption. Average power consumption is the sum of the total energy consumed by the system in Dynamic and Static Power modes, divided by the average system loop time, as shown in the figure below. Average power is important because it provides a single value, which can be used to accurately determine battery life or the total energy use of the system.

1. A method implemented by a low powered, integrated remote data acquisition platform in a distributed wireless monitoring system via a web-based program that comprising:
a. receiving over the wireless internet link from the cloud server a predetermined difference threshold for event triggering and sampling interval;
b. sampling by comparators a sensed parameter(s) on a dynamically programmable sample rate;
c. activating a data logger when the comparators sense a differential change in the sensed parameter exceeding the dynamically programmable difference threshold for event triggering from a dynamically programmable baseline value;
d. compression encoding the stored data;
e. logging the sensed value together with a relative time by the data logger as stored data until the parameter returns to the dynamically programmable baseline;
f. receiving over the wireless internet link from the cloud server a dynamically configurable sensor calibration, sample rate, trigger threshold information, reporting schedule and current time and date information;
g. receiving over the wireless internet link from the cloud server dynamically configurable sensor calibration and trigger threshold information;
h. transmitting the compression encoded stored data over the wireless internet link to the cloud server according to the dynamically configurable reporting schedule;
i. receiving over the wireless internet link from the cloud server device control parameters
j. sending control signals to actuators based on the received device control parameters.

2. The method of claim 1 wherein transmitting the compression encoded stored data over the wireless internet link to the cloud server according to the dynamically configurable reporting schedule comprises transmitting the compression encoded stored data when a predetermined threshold of data has been logged.

3. The method of claim 1 further comprising transmitting to the cloud server over the wireless internet link an alarm if a low battery capacity state is detected, if measured event exceeds a user defined threshold, and/or if measured event exceeds a user defined comparator difference.

4. The method of claim 1 further comprises low-power operating functions including:
a. Automatic verification of connectivity to cell network and then automatic verification of connectivity to the cloud server. If such connectivities are not made or if communications over the wireless internet link is disrupted, the data logger is returned to a sleep mode.
b. Two-way wireless synchronized reporting while the radio is powered off between reporting transmission or alarm events.
c. During nominal operations the sensor platform is in sleep mode, and all on-chip and off-chip peripherals are using little or no current until activated by change in the sensors' parameters. Thereby only logging time and measurement based on event trigger.
d. Internet time/data are updated at each transmission for accurate logging and reporting synchronization without the requirement of a crystal oscillating internal clock.

5. The method of claim 1 further comprising dynamically downloading over the wireless internet link application code for distributed processing.

6. The method of claim 1 further comprising performing data analysis and comparisons on sampled data prior to data being stored and transmitted.

8. The method of claim 1 wherein the sensed parameter is representative of weather, outdoor & indoor air quality, water level, water flow, water quality, fluid pressure, vibration, image, electric current, solar irradiance, soil moisture.

9. The method of claim 1 wherein the web-based dynamic configuration program permanently resides on the cloud server and is uniquely identified by elements of the Media Access Control address. The web-based configuration program is reviewed with each remote transmission and any changes are automatically updated to the remote location at that time.
